(19) United States
(12) Patent Application Publication
(10) Pub. No.: US 2017/0025660 A1
(43) Pub. Date: Jan. 26, 2017

(54) BATTERY ASSEMBLY USING PRINTED CIRCUIT BOARD SUBSTRATE INCLUDING BUS BAR

(71) Applicant: VITZROCELL CO. LTD., Chungcheongnam-do (KR)

(72) Inventors: Hye-Won SHIN, Chungcheongnam-do (KR); Jun-Ho SON, Cheonan-si (KR); Kwang-Il CHUNG, Suncheon-si (KR)

(21) Appl. No.: 14/805,903

(22) Filed: Jul. 22, 2015

(51) Int. Cl. H01M 2/20

(52) U.S. Cl. CPC H01M 2/204; H01M 2/206

(57) ABSTRACT

Disclosed is a battery assembly with a PCB substrate, comprising a bus bar stepped and end processed for enhanced assembly performance and electrical bonding reliability, and a PCB substrate having an assembling groove with an end of the bus bar and an insulating film for an improved stability.

### BACKGROUND

1. Technical Field

The present disclosure relates to a battery assembly using a PCB substrate comprising a bus bar, more specifically, to a battery assembly using a PCB substrate comprising a bus bar stepped and end processed for enhanced assembly performance and electrical bonding reliability and a PCB substrate comprising a bus bar having an assembling groove with an end of the bus bar and an insulating film for an improved stability.

2. Description of the Related Art

A conventional bus bar used to connect several battery modules in series or parallel with each other or used to connect safety elements is of a straight-line type, and is connected to the battery through a manual welding. When applying this type of bus bar to a PCB substrate, one end of the bus bar is connected to a surface of the PCB substrate by a soldering process.

FIG. 1 is a cross-sectional view of a PCB substrate having a bus bar according to the prior art.

As seen from FIG. 1, PCB substrate 10 according to the prior art is disposed on a battery E, and is electrically bonded to the battery E. In this embodiment, due to the thickness of PCB body 20, bus bar 40 cannot be in intimate contact with the battery E. As such, when a space between the bus bar 40 and the battery E is present, stable operation is impossible, and such un-intimate contact leads to an increase in contact resistance, which causes product quality and safety problems.

Meanwhile, FIG. 2 is a plan view showing a normal connection structure between a bus bar and a battery, and FIG. 3 is a plan view showing an abnormal connection structure between a bus bar and a battery.

As shown in FIG. 2, a plurality of bus bars 40 are installed on a PCB substrate body 20, and are disposed in opening H of the PCB substrate body 20 while maintaining a predetermined mutually parallel spaced interval. In this embodiment, the bus bar 40 may be physically enforced by the operator downwardly to be in electrical contact with the battery E.

However, as shown in FIG. 3, when at least one of the plurality of bus bars 40 is disposed adjacent to the other bus bar 40 or the other adjacent element, since no actions are taken in between the bus bars 40, an end of the bus bar 40 may move to contact the other bus bar 40 in assembly of battery, which may frequently cause a short circuit between the adjacently disposed bus bars 40.

In the related prior art, Korean Laid-open Patent Publication No. 2004-0101555 (published on Dec. 2, 2004) discloses a capacitor module and a capacitor battery comprising same.

### BRIEF SUMMARY

One object of the present disclosure is to provide a PCB substrate comprising a bus bar wherein the bar is configured to be stepped and end processed, and the PCB substrate is designed to have an assembling groove with an end of the bus bar and an insulating film, whereby excellent assembly performance and electrical bonding reliability can be achieved.

In order to accomplish the object of the present disclosure, according to an aspect of the present disclosure, there is provided a battery assembly, comprising: a battery having a positive electrode and a negative electrode; a PCB substrate body having an opening, provided on an upper portion of the battery; and a bus bar having one end mounted on the PCB substrate body and the other end extended from the one end into the opening and connected to the battery; wherein the bus bar is adapted to form a refractive type of convex part in the opening, and the convex part is electrically and physically connected to the battery, wherein the bus bar comprises a connecting portion connected to the PCB substrate body, a stepped portion having a refractive type of steps extended from the connecting portion and inserted into the opening in the refractive shape, and an extended portion extended from the stepped portion and extending outwardly of the opening, and wherein the positive electrode and the negative electrode of the battery are connected to safety elements.

In order to accomplish the object of the present disclosure, according to another aspect of the present disclosure, there is provided a battery assembly, comprising: a PCB substrate body having a plurality of openings for welding with a plurality of batteries; and bus bars having one end mounted on the PCB substrate body and the other end extended from the one end into the plurality of openings and connected to the plurality of batteries; wherein each of the bus bars is adapted to form a refractive type of convex part in the plurality of openings, and the convex part is electrically and physically connected to the batteries, wherein each of the bus bar comprises a connecting portion connected to the PCB substrate body, a stepped portion having a refractive type of steps extended from the connecting portion and inserted into the opening in the refractive shape, and an extended portion extended from the stepped portion and extending outwardly of the opening, and wherein positive electrodes and negative electrodes of the batteries are connected to safety elements.

In consideration of a space between the welding parts of the battery and the bus bar, the application of a refractive type of steps to the bus bar may allow for the PCB substrate with the bus bar to secure the assembly performance and reliability, and further the safety elements may provide an enhanced stability of the battery.

In addition, for the PCB substrate having such stepped and end-processed bus bar according to the present disclosure, the height of the steps in the bus bar may be adjusted according to the type of the battery, but also when the bus bar is configured to be end-processed to be fitted to the PCB substrate having a groove to fix the bus bar, the workability of soldering may be improved, and the short circuit caused by contact between the bus bars may be prevented.

Further, for the PCB substrate having such stepped and end-processed bus bars according to the present disclosure, when the bus bars are disposed adjacently to each other, installing of insulating films for isolating the respective bus bars in between the adjacent bus bars may further avoid the risk of the short-circuit.

### BRIEF DESCRIPTION OF THE DRAWINGS

The above and other aspects, features and advantages of the present disclosure will become apparent from the following description of exemplary embodiments given in conjunction with the accompanying drawings, in which:

FIG. 1 is a sectional view of a battery assembly with a PCB substrate having a bus bar according to the prior art.

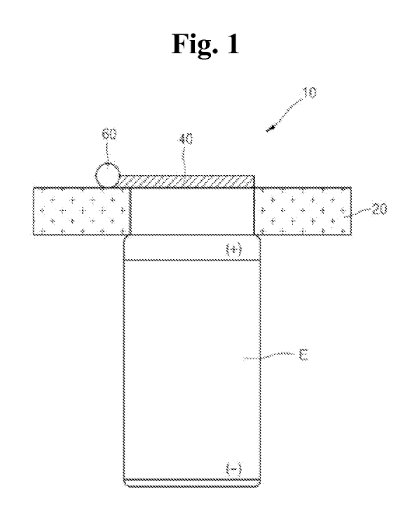

FIG. 2 is a plan view showing a normal connection structure between a bus bar and a battery.

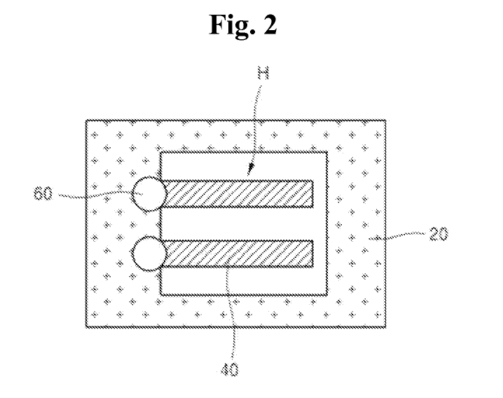

FIG. 3 is a plan view showing an abnormal connection structure between a bus bar and a battery.

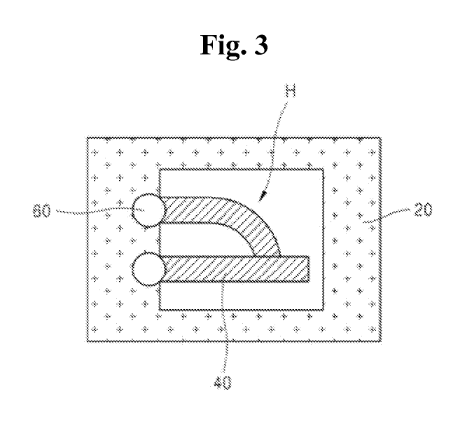

FIG. 4 is a sectional view of a battery assembly with a PCB substrate having a bus bar in accordance with an embodiment of the present disclosure.

FIG. 5 is an enlarged cross-sectional view of the PCB substrate of FIG. 4.

FIG. 6 is an enlarged plan view of the PCB substrate of FIG. 4.

FIG. 7 is a sectional view of battery assembly with PCB substrates having bus bars in accordance with another embodiment of the present disclosure.

FIG. 8 is a sectional view of a structure equipped with safety elements and bus bars in accordance with a still another embodiment of the present disclosure.

### DETAILED DESCRIPTION

Hereinafter, exemplary embodiments of the present disclosure will be described with reference to accompanying drawings.

Advantages and features of the present disclosure and methods of accomplishing the same reference to the following detailed description of exemplary embodiments and the accompanying drawings will be apparent. However, the present disclosure will be embodied in many different forms and is not limited to the embodiments set forth below, but the present embodiment is to complete the disclosure of the present invention, ordinary skill in the art is provided for fully convey the concept of the invention to those, the present disclosure will only be defined by the appended claims. The same reference numerals throughout the specification refer to like elements.

Hereinafter, a battery assembly with PCB substrate having a bus bar in accordance with exemplary embodiments of the present disclosure will be described with reference to accompanying drawings.

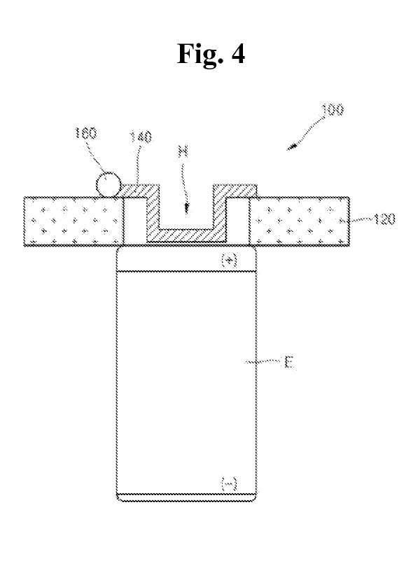

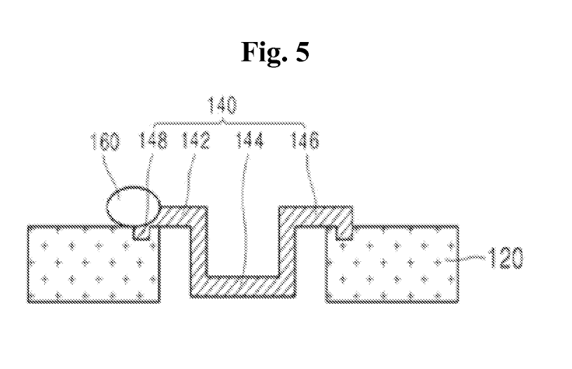

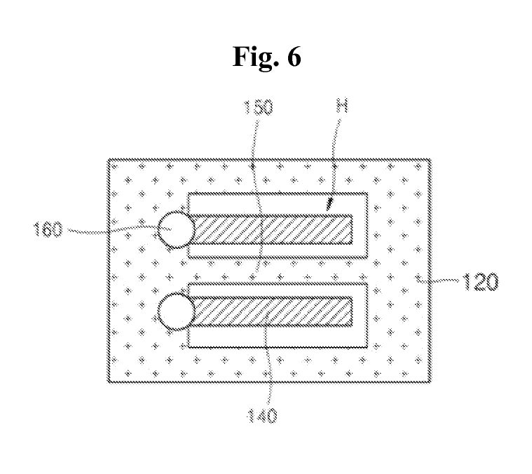

FIG. 4 is a sectional view of a battery assembly with a PCB substrate having a bus bar in accordance with an embodiment of the present disclosure, FIG. 5 is an enlarged cross-sectional view of the PCB substrate of FIG. 4, and FIG. 6 is an enlarged plan view of the PCB substrate of FIG. 4.

Referring to FIGS. 4 to 6, PCB substrate 100 having a bus bar according to an embodiment of the present disclosure includes a PCB substrate body 120, a bus bar 140, and a solder 160.

The PCB substrate body 120 is provided with an opening H arranged in a position corresponding to a battery E. The PCB substrate body 120 comprises, but not limited to, polyimide, prepreg, or the like. Although not shown in the Figures, a cell fuse, a replacement fuse, a bimetal, a second series field effect transistor (FET), a full discharge instruction element, a safety element, and the like may be mounted on the PCB substrate body 120.

A bottom of the opening of the PCB substrate body may be located on a top of the battery, or a bottom of the opening of the PCB substrate body may be located on the same line with a top of the battery in the horizontal direction.

One end of the bus bar 140 is mounted on the PCB substrate body 120, and the other end of the bus bar 140 is extended from the one end into the opening H and connected to the battery E. This bus bar 140 is configured to form a refractive type of convex part in a step-wise manner, corresponding to the opening H. The refractive type of convex part is inserted into the opening H to be in electrical and physical connection with the battery E. Thus, in consideration of a space between a welding part of the battery E and the bus bar 140, when steps are applied to the bus bar 140, structural advantages of the assembly performance and the reliability can be obtained.

More specifically, the bus bar 140 may include a connecting portion 142 connected to the PCB substrate body 120, a stepped portion 144 having a refractive type of convex part, extended from the connecting portion 142 and inserted into the opening H in the refractive shape, and an extended portion 146 extended from the stepped portion 144 and extending to the outside of the opening H. In this embodiment, the extended portion 146 of the bus bar 140 may be mounted to be fitted to the PCB substrate body, or mounted to be spaced apart from the PCB substrate body 120.

In addition, in order for the bus bar 140 to be fitted to the PCB substrate body 120, the bus bar 140 may further include an end processed portion 148, in which both ends of the end processed portion 148 may be configured to be refractive shapes parallel with the stepped portion 144. The end processed portion 148 may be a straight-line type, but not limited thereto. Although not specifically shown in the Figures, the end processed portion 148 may have a hook shape.

In this way, when the end processed portion 148 of the bus bar 140 is designed to have a hook shape, the end processed portion 148 having such hook shape may be fitted into a groove (not shown) provided in the PCB substrate body 120 to fix the bus bar 140 reliably, which can provide an improved workability of soldering with a solder 160 to be described later, and prevent a short circuit caused by a contact between the bus bars 140.

The bus bar 140 may be mounted simultaneously in a surface mount technology (SMT) configuration on the PCB substrate body 120 and the battery E. In this embodiment, the bus bar 140 may have the same thickness as the connecting portion 142, the stepped portion 144, and the extended portion 146, respectively, but preferably may be formed by simultaneous molding with a press molding. In particular, the bus bar 140 according to some embodiment of the present disclosure has a refracted shape of structure in which the stepped portion 144 may be configured to have a refractive type of downwardly convex shape. In this embodiment, preferably the stepped portion 144 of the bus bar 140 has a length corresponding to a width of the opening H. When the length of the stepped portion 144 is greater than the width of the opening H, the stepped portion 144 may not be stably inserted into the opening H, and when the length of the stepped portion 144 is shorter than the width of the opening H, the stepped portion 144 may not be stably mounted on the PCB substrate body 120.

According to some embodiments, a solder 160 may serve to electrically connect the PCB substrate body 120 with the bus bar 140. In this embodiment, the solder 160 may be formed at both ends of the opening H penetrating through the PCB substrate body 120, or may be formed only on either one end.

FIG. 6 is an enlarged plan view showing the PCB substrate of FIG. 4.

As shown in FIG. 6, the PCB substrate 100 having a bus bar according to an embodiment of the present disclosure may further include an insulating film 150.

In this embodiment, the insulating film 150 is formed to cross the center of the opening H to electrically separate the bus bars 140 to each other. Thus, since the insulating film 150 may be designed to isolate the bus bars 140 to each other, even though the bus bars 140 are adjacent to each other, the insulating film 150 may function as a protective film such that the risk of short circuit may be basically prevented.

In this embodiment, preferably the insulating film 150 may be integrally formed with the PCB substrate body 120, which can provide a simplified structure, and enable to design the insulating film 150 without any additional cost, as well as have a structure favorable for stiffness.

For the PCB substrate having a bus bar according to the above-described embodiments of the present disclosure, in consideration of the space between the welding part of the battery and the bus bar, the application of such step-wise convex part to the bus bar may lead to improved assembly performance and reliability.

Further, in the PCB substrate having the bus bar adapted to be stepped and end processed according to an embodiment of the present disclosure, the steps applied to the bus bar may be adjusted to control the height of the steps with the type of battery. In addition, the bus bar may be end processed for both ends thereof to be fitted to the PCB substrate. When the PCB substrate designed to have a groove is secured to the bus bar, improved workability of soldering can be obtained, and the short circuit caused by contact between the bus bars can also be prevented.

In addition, in the PCB substrate having the bus bar adapted to be stepped and end processed according to an embodiment of the present disclosure, when a plurality of bus bars are designed to be adjacent to one another, insulating films for isolating the bus bars to one another may be installed therebetween to prevent the risk of the short circuit, or the like.

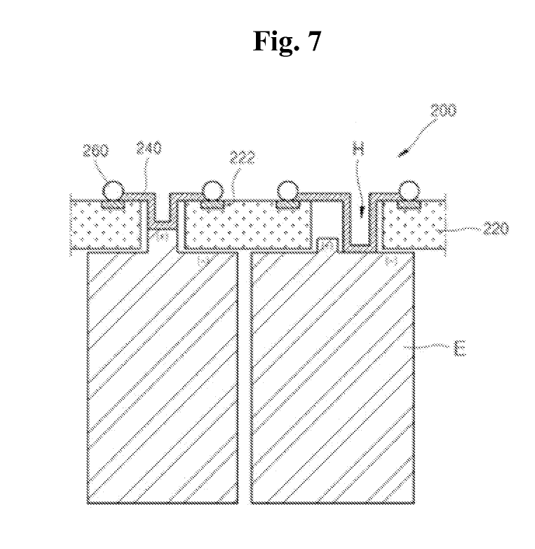

FIG. 7 is a sectional view of battery assembly with PCB substrates having bus bars in accordance with another embodiment of the present disclosure.

Referring to FIG. 7, the PCB substrates 200 having bus bars 240 according to a further embodiment of the present disclosure may include a PCB substrate body 220 having a plurality of openings H, and each of the bus bars 240 having one end mounted on the PCB substrate body 220 and the other end extended from the one end into the plurality of openings H and connected to each of the plurality of batteries E for welding.

The PCB substrate body 220 is provided with the openings H in a position corresponding to each of the plurality of batteries E, and has an external connection terminal 222 disposed in an adjacent position with the opening H.

The bus bar 240 is substantially the same as the bus bar as described hereinabove according to some embodiments of the present disclosure with reference to FIGS. 4 to 6, and therefore overlapping descriptions will be omitted.

The plurality of batteries E may be arranged in an array of, for example, such as 2×2, and each of the batteries E may be connected in series with each other to be a single assembly to supply a high voltage of power. In this embodiment, each of the batteries E may be any one of a cylindrical, rectangular, or hexagonal shape, but not limited thereto, and may be modified in various shapes whenever necessary.

In this embodiment, as depicted in FIG. 7, the batteries E are connected in series to the PCB substrate body 220 in an array of 2×2, but not limited thereto, and may be arranged in various ways, for example, such as 2×3, 3×3, 2×4, 4×4, and the like.

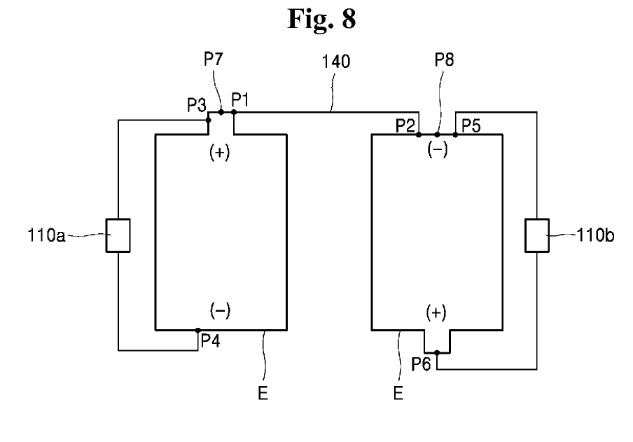

FIG. 8 is a cross-sectional view showing an arrangement provided with safety elements and bus bars according to a still another embodiment of the present disclosure.

Referring to FIG. 8, the PCB substrate may include safety elements, wherein the safety elements may be connected to a positive electrode and a negative electrode of each of the batteries, and each of the batteries may be connected with the bus bars 140. Such arrangement may be applied as a series or parallel configuration. Preferably, safety elements 110a and 110b may be provided for the safety of each battery. When damages occur to the batteries, the safety elements 110a and 110b may serve to lower the state of charge of the battery to enhance the stability of the battery. Vanadium-based oxides may be used for the safety elements, and may include, but not limited to, vanadium oxides (V₂O₅), pyro-vanadic acids (H₄V₂O₇), or the like.

FIG. 8 shows P1 to P8 welding points, in which P1 and P2 are welding points to connect with the bus bars 140, respectively, and P3 to P6 are welding points to connect with the safety elements, respectively.

Although some embodiments have been provided to illustrate the present disclosure, it will be apparent to those skilled in the art that the embodiments are given by way of illustration, and that various modifications and equivalent embodiments can be made without departing from the spirit and scope of the present disclosure. Accordingly, the scope of the present disclosure should be limited only by the accompanying claims and equivalents thereof.

List of reference numbers

| | | | |
|---|---|---|---|
| 100: | PCB substrate | 120: | PCB substrate body |
| 140: | bus bar | 142: | connecting portion |
| | | | of bus bar |
| 144: | stepped portion of | 146: | extended portion of |
| | bus bar | | bus bar |
| 148: | end processed portion | | |
| | of bus bar | | |
| 150: | insulating film | 160: | solder |
| H: | opening | E: | battery |
| 110a, 110b: | safety elements | P1~P8: | welding points |

What is claimed is:

1. A battery assembly, comprising:
a battery having a positive electrode and a negative electrode;
a PCB substrate body having an opening, provided on an upper portion of the battery; and
a bus bar having one end mounted on the PCB substrate body and the other end extended from the one end into the opening and connected to the battery;
wherein the bus bar is adapted to form a refractive type of convex part in the opening, and the convex part is electrically and physically connected to the battery, wherein the bus bar comprises a connecting portion connected to the PCB substrate body, a stepped portion having a refractive type of steps extended from the connecting portion and inserted into the opening, and an extended portion extended from the stepped portion and extending outwardly of the opening, and wherein the positive electrode and the negative electrode of the battery are connected to safety elements.

2. The battery assembly according to claim 1, wherein a bottom of the opening of the PCB substrate body is located on a top of the battery, or a bottom of the opening of the PCB substrate body is located on the same line with a top of the battery in the horizontal direction.

3. The battery assembly according to claim 1, wherein the extended portion is mounted to be fitted to or be spaced from the PCB substrate body.

4. The battery assembly according to claim 1, wherein the bus bar further comprises an end processed portion to be fitted to the PCB substrate body, wherein both ends of the end processed portion are adapted to have a refractive shape parallel with the stepped portion.

5. The battery assembly according to claim 4, wherein the end processed portion has a hook shape, wherein the end processed portion having the hook shape is fitted into a groove provided in the PCB substrate body.

6. The battery assembly according to claim 1, wherein the bus bar is mounted in a surface mount technology (SMT) configuration on the PCB substrate body and the battery simultaneously.

7. The battery assembly according to claim 1, wherein the PCB substrate further comprises a solder for electrically connecting the PCB substrate body with the bus bar.

8. The battery assembly according to claim 1, wherein the PCB substrate further comprises an insulating film formed to cross the center of the opening, for electrically separating the bus bars to each other.

9. The battery assembly according to claim 8, wherein the insulating film is formed integrally with the PCB substrate body.

10. A battery assembly, comprising:
a PCB substrate body having a plurality of openings for welding with a plurality of batteries; and
bus bars having one end mounted on the PCB substrate body and the other end extended from the one end into the plurality of openings and connected to the plurality of batteries;
wherein each of the bus bars is adapted to form a refractive type of convex part in the plurality of openings, and the convex part is electrically and physically connected to the batteries, wherein each of the bus bar comprises a connecting portion connected to the PCB substrate body, a stepped portion having a refractive type of steps extended from the connecting portion and inserted into the opening, and an extended portion extended from the stepped portion and extending outwardly of the opening, and wherein positive electrodes and negative electrodes of the batteries are connected to safety elements.

11. The battery assembly according to claim 10, wherein the plurality of batteries are connected in series with each other.

12. The battery assembly according to claim 10, wherein the plurality of batteries are connected in parallel with each other.
